(19) United States
(12) Patent Application Publication
(10) Pub. No.: US 2012/0256096 A1
(43) Pub. Date: Oct. 11, 2012

(54) METHOD AND DEVICE FOR MONITORING MOVING OBJECTS

(76) Inventors: Peter HEIMLICHER, Fribourg (CH); Charles RHÊME, Posieux (CH)

(21) Appl. No.: 13/415,958

(22) Filed: Mar. 9, 2012

(30) Foreign Application Priority Data
Apr. 8, 2011 (EP) 11161684.3

(51) Int. Cl. G01J 1/04

(52) U.S. Cl. 250/372; 250/393

(57) ABSTRACT

A method and a device for monitoring objects moving along a trajectory. The objects include a section that is transparent or translucent. The objects subsequently cross a light beam at the section. The presence or absence of an object is determined during a transitional time period during which substantially no light or light within a wavelength range substantially untransmittable through the section is detected. A monitoring device generates an output signal based on the light detection indicating the presence or absence of an object.

### FIELD OF THE INVENTION

The invention relates to a method for monitoring objects that are moved along a trajectory with a relative distance from each other, the objects comprising a section that is transparent or translucent in the visible light spectrum, wherein a light beam is directed transverse to the trajectory such that the objects subsequently cross the light beam at said section, and wherein light from the light beam is detected by a detector. The invention further relates to a monitoring device of a generic kind comprising a light emitter and a detector.

### BACKGROUND OF THE INVENTION

Such a monitoring device and method is used, for instance, in a bottling line for glass bottles or PET bottles. Before or after an automatized filling of these bottles, they are often transported via a conveyor belt from or to another automatized processing step, such as cleaning, sealing, labeling or packaging. The subsequent processing step is usually synchronized with the preceding procedure taking into account, for instance, an expected filling time for each bottle or a predicted feeding frequency of the conveyor belt affecting the relative distance of the bottles on the conveyor belt. Thus, for quality assurance, the bottling process requires a reliable detection mechanism if the preceding procedure meets the expected output or if at least one of the predicted bottles is delayed or absent at the expected time.

Common monitoring devices comprise a light barrier with a detector that must respond to small changes in the intensity of the detected light. In principle, the intensity variations are provoked by a change of the refractive index when a bottle crosses the light beam. Due to the small magnitude of this effect, however, the reliability of the detection mechanism is limited. Further limitations arise from the fact that the surface quality of the bottles often varies during one manufacturing phase or in between subsequent production cycles. For instance, the side walls of the bottles are often lubricated with a soap solution after their cleaning which leads to a change of their refractive index. As a consequence, the sensitivity of the detection mechanism needs to be adapted frequently in order to meet the momentary properties of the moving objects.

### OBJECTS AND SUMMARY OF THE INVENTION

Accordingly, it is an object of the present invention to provide an improved monitoring method and monitoring device, which is comparatively simple and cost-efficient to realize and yet allows a highly reliable monitoring of the moving objects.

Relating to one preferred aspect of the monitoring method, the invention suggests that the light beam comprises light at a wavelength range that is substantially untransmittable through the section of an object, and that the presence of an object is determined on the basis of a transitional time period during which substantially no light within the untransmittable wavelength range is detected by the detector. Thus, a determination of the presence of an object at a certain position on the trajectory preferably relies on a detection of a complete cut-off of the light beam over the untransmittable wavelength range. This can greatly improve the reliability of the monitoring process and can be implemented in a cost-efficient manner.

According to another preferred aspect of the monitoring method, the absence of an object is determined on the basis of a transitional time period during which light within said untransmittable wavelength range is detected by said detector. Advantageously, an expected time may be provided for each of the objects to cross said light beam. Moreover, the absence of an object may be determined when light within said untransmittable wavelength range is detected by the detector during the expected time. In this way, not only the presence of an object during an arbitrary time may be determinable, but alternatively or additionally the absence of an object during its expected time. Advantageously, this can be employed to further improve the quality assurance during a production cycle.

According to the invention, these advantages can also be achieved with a device comprising an emitter that is configured to emit light comprising a wavelength range that is substantially untransmittable through a section of an object, the untransmittable wavelength range being at least partially outside the visible light spectrum, and an output circuit for generating an output signal that is representative of the detected light intensity relative to a predetermined detection threshold value, the output signal indicating the presence or absence of an object during a transitional time period.

The following preferred embodiments of the invention may be advantageously implemented in at least one of the monitoring method and the montoring device.

The light within the untransmittable wavelength range may be absorbable and/or reflectable by the section. Preferably, at least fifty percent, more preferred at least eighty percent, of the wavelength range or the emission power of the light beam is untransmittable through said section. Most preferred, the light beam substantially only consists of a wavelength range that is untransmittable through the section. Correspondingly, the emitter is preferably configured to emit light only within the untransmittable wavelength range. More preferred, the wavelength range of emitted light is outside the visible light spectrum. According to the invention, each of these measures can further improve the reliability of the detection mechanism. Moreover, these measures can also contribute to a cost-efficient implementation of the proposed monitoring device.

Preferably, the detected light intensity corresponds to the integrated intensity of the light spectrum that is detectable by the detector. Thus, no wavelength determination must be employed and a rather basic detection system that is wavelength-insensitive can be applied for a detection of the cut-off of the untransmittable wavelength range of the light beam. For instance, the detector may be constituted by a wavelength-insensitive semiconductor device, such as a photo-diode.

Preferably, the output signal generated by the output circuit is based on a comparison of the detected light intensity and a predetermined detection threshold value. In particular, a comparator may be used in the output circuit in order to determine the output signal based on this comparison. Preferably, the output signal comprises or consists of two detection signal states. The first signal state may indicate if the detected light intensity is below said predetermined detection threshold value during said transitional time period. The second signal state may indicate if the detected light intensity is equal or above said predetermined detection threshold value during said transitional time period. Advantageously, each of the two detection signal states may consist of a different constant signal value. For instance, the signal value of one of the signal states may be zero, corresponding to an “off”-mode of the light detection, and the signal value of the other signal state may be greater than zero, corresponding to an “on”-mode of the light detection. In this way, a cost-efficient and yet reliable detection mechanism for the moving objects can be realized.

In particular, a rather high value of the detection threshold value close to the emission power of the light beam may be applicable. Such a configuration may be applied, if the emitted light beam only consists of light that is untransmittable through the section of the objects. In order to increase the detection reliability, the detection threshold value preferably corresponds to less than one half, more preferred to less than one third, of the emission power of the light beam. This configuration may be advantageous, if only a part of the wavelength range of the emitted light beam is untransmittable through the section of the objects or if the light beam is untransmittable over its complete wavelength range. Most preferred, the detection threshold value corresponds to a power value of substantially zero in order to maximize the detection reliability.

Preferably, the section is transparent or translucent only above a limiting wavelength value, preferably only above 370 nm and more preferred only above 310 nm. According to one preferred application, the section is constitued by polyethylene terephtalate (PET). According to another preferred application, the section is constitued by glass, more preferred soda-lime glass. A particularly preferred material is soda-lime glass with a chemical composition of about 72% SiO₂, 13% Na₂O and 5% Ca0.

Advantageously, these materials cover the packaging material of a large variety of conventional products, in particular for the pharmaceutical and food industries, resulting in a wide range of applicability of the present invention. Preferably, the objects are production objects of a production line. More preferred, the production objects are receptacles and the section is a wall section of these receptacles. Correspondingly, a preferred use of the monitoring device and/or method is in a filling line for receptacles, more preferred in a bottling line. In this case, the receptacles may be disposed at said trajectory before and/or after an automized filling process.

In a preferred configuration of the invention, the emitter is adapted to emit light substantially only within the UV-spectrum, more preferred only within the UV-B and/or UV-C spectrum. In this way, an interference of the light beam within the visible light spectrum can be avoided. On the one hand, this allows a reliable detection system for many applications. In particular, any corruptive interference of ambient light during daily sunlight conditions or due to a common room illumination with the proposed detection mechanism can be circumvented. On the other hand, any distracting visual effect on people close to the monitoring environment can also be avoided.

According to another preferred configuration, light with a defined polarization is provided in the light beam at the position of the trajectory. In this way, the detection reliability can be further improved since an emission of polarized light can provide a unique recognition feature of the emitted light that can be distinct from the detected light. In particular, parts of the light beam that are reflected from the surface of the moving objects with an unchanged polarization angle and other disturbing influences from the environment can be eliminated. In order to provide such a distinction for the detected light, the detector is preferably configured to substantially only detect light components with an orthogonal polarization with respect to the defined polarization of the emitted light, such that only components of the light beam with an orthogonal polarization with respect to the emission polarization may be detectable. Furthermore, the light beam is preferably directed towards the detector through a means for changing the polarization of said light beam. In this way, an error-free identification of the fraction of the emitted light that has been passing through the trajectory of the moving objects can be achieved. Such a means for changing the polarization may be constituted by a polarization rotator, which rotates the polarization angle of the emitted light, and/or a depolarizer, which converts the emitted light into unpolarized light.

Accordingly, the emitter of the monitoring device is preferably provided with a polarizer such that the light from the light beam being crossed by the production objects is provided with the defined emission polarization. Correspondingly, the detector is preferably provided with another polarizer for providing said light beam with an orthogonal polarization with respect to said emission polarization before the light of said light beam is detected. The polarizer may be disposed in front of the emitter/detector in the same enclosure or spaced apart at a more distant position of the light beam. Preferably, a Brewster's angle polarizer is employed. Alternatively or additionally, an absorptive polarizer, such as a wire-grid polarizer or a crystal polarizer, or a beam-splitting polarizer, such as a prism or a thin-film polarizer, is also conceivable.

In order to allow a change of polarization of the polarized light beam, the monitoring device preferably comprises a means, in particular a polarization rotator and/or a depolarizer, that is disposable in said light beam before the polarizer of the detector. Advantageously, the means for changing the polarization may be constituted by a reflector, which may yield a polarization rotation or a depolarization of the reflected light beam. Preferably, a reflector with a matrix of corner cubes, in particular consisting of UV-transparent material, is employed. More preferred, the reflector is adapted to provide a total reflection of the incoming light beam auxiliary to a rotation of the polarization angle and/or a depolarization.

In a further preferred configuration of the invention, the emitter is a spontaneously emitting light source. More preferred, the emitter is constituted by at least one light emitting diode (LED) or an array of LEDs. This can contribute to an inexpensive and yet effective monitoring system. Preferably, at least one LED with a hemispherical lens is applied. This may yield a collimated light beam over comparatively long optical working distances. In this way, the application of a stimulated emission source can be avoided. Additionally or alternatively, a stimulated emission source may also be applied.

The transitional time period during which substantially no light and/or during which light within said untransmittable wavelength range is detected by the detector may depend on the moving speed of the objects. This may allow a particularly accurate monitoring of the objects. In particular, the transitional time period may be simply given by the respective total time of the objects crossing or not crossing the light beam. Alternatively, the transitional time period may be fixed in the form of a predetermined threshold time value. The presence or absence of an object may then be judged based on a continous detection or failing detection of light within the untransmittable wavelength range and within a period not shorter than said threshold time value.

Moreover, the emitter may be operated in a continuous wave (cw) or in a pulsed mode operation. In either case, said transitional time period is preferably evaluated with respect to the effective time periods of light emission from the emitter.

In another preferred configuration of the invention, the detector is at least one photodiode. More preferred, the detector exhibits a high sensitivity in the UV-range. Advantageously, a silicon based photodiode may be employed, preferably equipped with an UV-glass window. This can further contribute to an inexpensive and yet effective monitoring system.

Preferably, the emitter is disposed laterally with respect to the height of the objects moved along said trajectory. Such a configuration allows a convenient implementation of the monitoring device in an already operating production line. More preferred, the light beam is disposed substantially perpendicular with respect to the trajectory of the objects.

Preferably, the objects are continuously moved along the trajectory in order to allow an uninterrupted and rapid process flow. According to a preferred application, the trajectory extends in a straight line. For instance, the monitoring device may be disposed at a conveyor belt.

According to a preferred embodiment, the emitter and the detector are arranged at opposed sides with respect to the trajectory. According to another preferred embodiment, the emitter and the detector are disposed at the same side with respect to the trajectory and a reflector is disposed on the opposite side. The latter configuration has the particular advantage, that the emitter and the detector can be provided with a common control and/or power supply. Thus, the alignement of the detector position with respect to the emitter position can be simplified and a misalignment during the installation or the cabling of the device can be avoided. As a further advantage, the emitter and the detector can be easily wired and synchronized with each other. Preferably, the emitter and the detector are arranged in a common enclosure. More preferred, a polarizer for the emitter and/or another polarizer for the detector are also arranged in the enclosure.

Preferably, the reflector is configured to reflect at least part of the wavelength range that is untransmittable through the section back into the direction of the detector. More preferred, the reflector is configured to reflect light in the UV-range. Most preferred, the reflector is constituted by a material transparent to UV-light. In particular, a UV-transparent polymere can be used. Alternatively, the reflector may be provided with a metallized upper surface to allow a back reflection of UV-light.

According to a preferred implementation, a back reflector with a matrix of corner cubes, preferably consisting of the UV-transparent material, is employed, which can advantageously provide a reflection of the incoming light beam, more preferred a total reflection of the light beam. Such a back reflector may be also exploited for a rotation of the polarization angle and/or depolarization of the incoming light beam yielding the above mentioned additional advantages. Alternatively, a back reflector comprising a metallized upper surface can be used.

### BRIEF DESCRIPTION OF THE DRAWINGS

The invention will be described in more detail in the following description of preferred exemplary embodiments with reference to the accompanying drawings. In the drawings:

FIG. 1 is a schematic perspective view of a monitoring device according to a first embodiment; and

FIG. 2 is a schematic perspective view of a monitoring device according to a second embodiment.

### DETAILED DESCRIPTION OF THE PREFERRED EMBODIMENTS

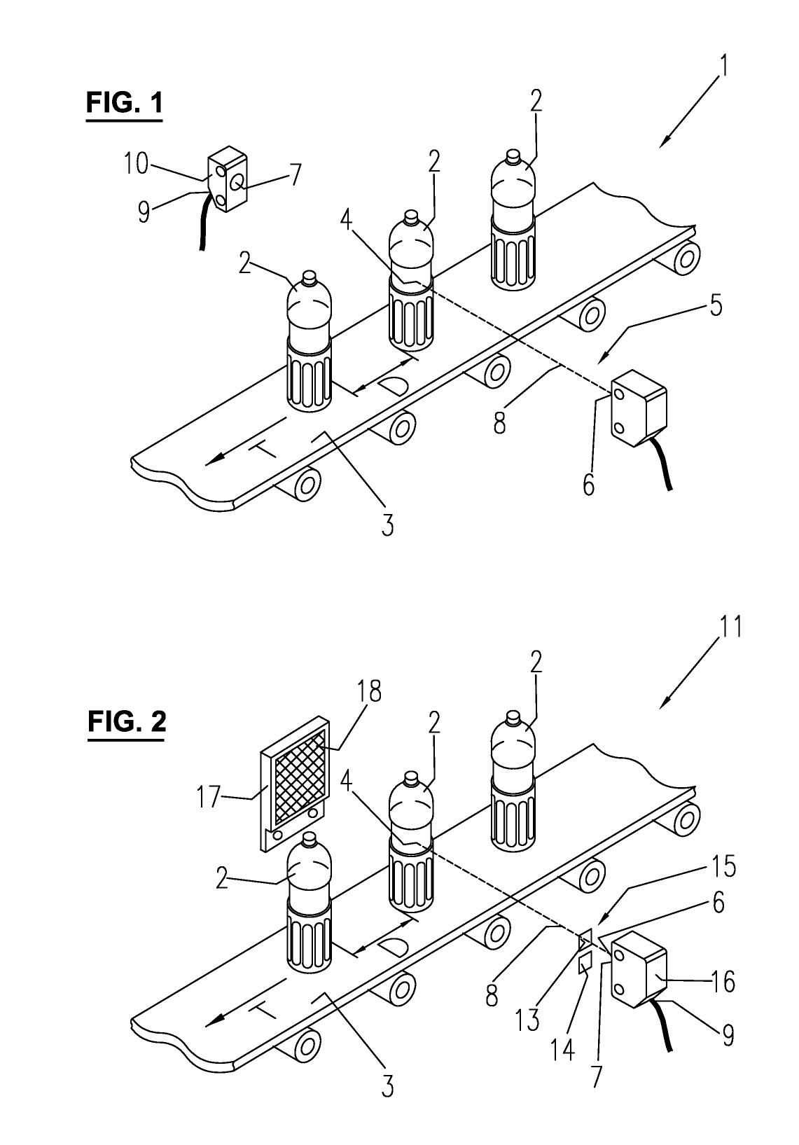

In the production line 1 shown in FIG. 1 empty bottles 2 are subsequently positioned on a conveyor belt 3 in an automatic process. The longitudinal extension of the conveyor belt 3 defines a trajectory T, along which the bottles 2 are moved with a relative distance D from each other. The walls of bottles 2 consist of a material that is transparent to visible light, for instance a soda-lime glass or PET.

The relative distance D depends on the frequency in which the receptacles 2 are placed on the conveyor belt 3 by the preceding automated process. In many applications, the relative distance D is ideally constant in between two subsequent bottles 2 and may correspond to an expected value. For quality assurance, however, it is necessary to verify the expected presence of a receptacle 2 at the predicted time interval in order to ensure a correct mode of operation of a subsequent process step, such as a filling service for the bottles. In other applications, the expected relative distance D is not known from the feeding frequency of the preceding process and must be determined each time in order to match the mode of operation of the subsequent process to the arrival time of the receptacles 2. In further applications, the relative distance D is of little interest, but the number of receptacles 2 passing during a certain time interval over the conveyor belt 3 must be counted to determine the process output.

In order to allow such a desired monitoring of the bottles 2 within the production process, a monitoring device 5 is arranged next to the conveyor belt 3. The monitoring device 5 comprises a light emitter 6 disposed laterally on one side of the conveyor belt 3 and a detector 7 disposed laterally on its other side. The emitter 6 and detector 7 are arranged substantially at the same height with respect to the bottles 2 passing in between. In this way, a light beam 8 emitted from emitter 6 is directed in a substantially perpendicular direction with respect to trajectory T such that the bottles 2 subsequently cross the light beam 8 at a wall section 4. The wall section 4 is located approximately in the middle portion of the side walls of bottles 2.

The emitter 6 is constituted by at least one light emitting diode (LED) with a hemispherical lens producing a collimated light beam 8. Its emission wavelength lies fully within the UV-B (280 nm-315 nm) and UV-C (100 nm-280 nm) range. The detector 7 is constituted by a silicon photodiode that is capable of detecting light within the UV-wavelength range. The detectable wavelength range may also extend into the visible light spectrum.

This particular choice of the range of the emission and detection wavelengths has been carried out under careful consideration of the specific optical properties of the materials referenced above, in particular their light transmission properties. Thus, a complete absorption and/or reflection of the wavelength range below 320 nm in the case of soda-lime glass and below 370 nm or below 310 nm in the case of PET (depending on its quality) is exploited in the device 5 to achieve a superior monitoring in a production line 1 for those or similar materials.

As a result, the light beam 8 runs from the emitter 6 to the detector 7 only during the transitional time intervals in which none of bottles 2 crosses the light beam 8. In contrast, the light beam 7 is fully absorbed and/or reflected by wall section 4 of the bottles 2 during the transitional time periods in which each of the bottles 2 crosses the light beam 7. During these periods, substantially no light within the emission wavelength range of emitter 6 arrives at the detector 7.

The enclosure 10 of detector 7 further contains an output circuit 9 which generates an output signal in dependence of light within the emitted wavelength range being detected and/or not detected by detector 7. In this way, relevant process information, whether any bottle 2 is present at an arbitrary time interval and/or whether any bottle 2 is not present at an expected time interval and/or the number of passing bottles 2 counted over a predetermined time interval can be advantageously determined and transmitted to the subsequent automated process.

FIG. 2 depicts a production line 11 that essentially corresponds to the previously described production line 1, except that a different monitoring device 15 is applied. The monitoring device 15 comprises an enclosure 16 in which the emitter 6, the detector 7 and the output circuit 9 are contained. The enclosure 16 is disposed laterally on one side of the conveyor belt 3.

A reflector 17 is disposed on the other side of the conveyor belt 3 substantially at the same height as enclosure 16 with respect to the bottles 2 passing in between. The reflector 17 comprises a matrix of corner cubes 18 made out of a polymer transparent to UV-light. Alternatively or additionally, the reflector 17 may be provided with a metallized upper surface. Thus, a reflection of the light beam 8 emitted from emitter 6 back to the detector 7 is provided during a time period in which no bottle 2 is present at the intersection of light beam 8 and trajectory T.

In order to further improve the detection reliability, a polarizer 13 is disposed within the light beam 8 in between the emitter 6 and the conveyor belt 3. The polarizer 13 produces light with a defined polarization state. In the present case, a linear polarizer 13, such as a wire-grid, is employed for polarizing the light beam 8 in a linear direction of its field vector. In this way, the light stemming from the emitter 6 is characterized by its unique emission polarization. Another polarizer 14 is arranged in between the detector 7 and the conveyor belt 3. The polarizer 14 is configured to provide a polarization that is orthogonal to the polarization provided by the first polarizer 13. Furthermore, the matrix of corner cubes 18 of reflector 17 constitutes a device which provides a rotation of the polarization angle of the light beam 8 during its reflection. Thus, a reliable identification of the emitted light can be provided by means of the detector 7 due to its configuration to detect only the components of a light field vector with a detection polarization that is orthogonal to the emission polarization. In particular, light reflected or scattered from the surface at section 4 of the objects 2 is not detectable by detector 7. In this way, the change of the polarization angle of light bean 8 at the opposing side of trajectory T with respect to emitter 3 allows an unambigous identification of the light fraction that has been passing through the trajectory T of moving objects 2. In particular, a distinction with respect to a fraction of the emitted light that has been reflected from moving object 2 and therefore has no corresponding polarization properties can be obtained.

Advantageously, the emitter 6 and the detector 7 are arranged in the common enclosure 16. According to a preferred embodiment, the polarizer 13 for the emitter 6 and/or the polarizer 14 for the detector 7 are also arranged in this enclosure 16.

In consequence, the above described monitoring methods can be executed in an analogous manner with the monitoring device 15.

The above described preferred embodiments are intended to illustrate the principles of the invention, but not to limit the scope of the invention. Various other embodiments and modifications to those preferred embodiments may be made by those skilled in the art without departing from the scope of the present invention.

1. A method for monitoring objects that are moved along a trajectory with a relative distance from each other, the objects comprising a section that is transparent or translucent in the visible light spectrum, wherein a light beam is directed transverse to said trajectory such that the objects subsequently cross said light beam at said section, and wherein light from said light beam is detected by a detector, wherein said light beam comprises light at a wavelength range that is substantially untransmittable through said section and the method further comprises at least one of the steps
that the presence of an object is determined on the basis of a presence transitional time period during which substantially no light within said untransmittable wavelength range is detected by said detector;
that the absence of an object is determined on the basis of an absence transitional time period during which light within said untransmittable wavelength range is detected by said detector.

2. The method according to claim 1, wherein said light beam consists of light at a wavelength range that is untransmittable through said section.

3. The method according to claim 1, wherein light with a defined polarization is provided in said light beam at the position of said trajectory.

4. The method according to claim 3, wherein said detector is configured to substantially only detect light components with an orthogonal polarization with respect to said defined polarization and said light beam is directed towards said detector through a means for changing the polarization of said light beam, in particular a polarization rotator or a depolarizer or both.

5. The method according to claim 1, wherein said objects are receptacles and said section is a wall section of said receptacles.

6. The method according to claim 1, wherein said section is transparent or translucent substantially only above a limiting wavelength value, preferably above 310 nm.

7. The method according to claim 1, wherein said section is constitued by polyethylene terephtalate (PET) or soda-lime glass or both.

8. The method according to claim 1, wherein said light at a wavelength range that is substantially untransmittable through said section comprises light that is absorbable or reflectable or both by said section.

9. A device for monitoring objects that are moved along a trajectory with a relative distance from each other, the device comprising
an emitter for directing a light beam transverse to said trajectory such that the objects subsequently cross said light beam at a section, and
a detector for detecting light from said light beam,
wherein said emitter is configured to emit light comprising a wavelength range that is substantially untransmittable through said section, said untransmittable wavelength range being at least partially outside the visible light spectrum, and that the device further comprises an
output circuit for generating an output signal representative of the detected light intensity relative to a predetermined detection threshold value, said output signal indicating the presence or absence or both of an object during a transitional time period.

10. The device according to claim 9, wherein said detection threshold value corresponds to less than one half, more preferred to less than one third, of the emission power of said light beam, most preferred to a power value of substantially zero.

11. The device according to claim 9, wherein said emitter is provided with a polarizer such that the light from said light beam being crossed by the production objects is provided with a defined emission polarization.

12. The device according to claim 11, wherein it further comprises a means for changing the polarization of said light beam, in particular a polarization rotator or a depolarizer or both, that is disposable in said light beam and said detector is provided with another polarizer for providing said light beam with an orthogonal polarization with respect to said emission polarization before the light of said light beam is detected.

13. The device according to claim 9, wherein said emitter is a spontaneously emitting light source.

14. The device according to claim 9, wherein said emitter is configured to emit light substantially only within the UV-B or UV-C spectrum or both.

15. The device according to claim 9, wherein said detector is a photodiode.

16. The device according to claim 9, wherein said emitter and said detector are arranged at opposed sides with respect to said trajectory.

17. The device according to claim 9, wherein it comprises a reflector that is disposable in said light beam at the opposite side of said trajectory with respect to the position of said emitter and said detector.

18. The device according to claim 17, wherein said reflector is constituted by a material transparent to UV-light.

19. The device according to claim 17, wherein said reflector is provided with a metallized upper surface to allow a back reflection of UV-light.

20. Use of the device according to claim 9 in a filling line for receptacles.
